(19) United States
(12) Patent Application Publication
(10) Pub. No.: US 2026/0092861 A1
(43) Pub. Date: Apr. 2, 2026

(54) HIGH PRESSURE AND HIGH TEMPERATURE ANODE AND REFERENCE ELECTRODES ASSEMBLIES

(71) Applicant: Battelle Memorial Institute, Columbus, OH (US)

(72) Inventors: Lindy E. DEJARME, Columbus, OH (US); Julia STOWE, Avon, OH (US); Kavitha DASU, Powell, OH (US); Samer Mohamad AL-DIRANI, Columbus, OH (US); Ian HAGGERTY, Powell, OH (US); Blake HOLLIS, Port Orange, FL (US); Mike MILLER, Worthington, OH (US); Amira RASOUL, Hilliard, OH (US); Stephen ROSANSKY, Tampa, FL (US); Justin GOSSARD, Hilliard, OH (US)

(73) Assignee: BATTELLE MEMORIAL INSTITUTE, Columbus, OH (US)

(21) Appl. No.: 19/346,264

(22) Filed: Sep. 30, 2025

Related U.S. Application Data
(60) Provisional application No. 63/701,464, filed on Sep. 30, 2024.

(51) Int. Cl. G01N 17/02; C23F 13/04; C23F 13/22; G01N 17/00

(52) U.S. Cl. CPC G01N 17/02; C23F 13/04; C23F 13/22; G01N 17/006; C02F 2303/08

(57) ABSTRACT

A system and method for providing cathodic protection in supercritical water oxidation (SCWO) processes, designed to prevent corrosion of metallic components under high-pressure and high-temperature conditions. The system includes a graphite anode and a noble metal reference electrode housed in ceramic-insulated assemblies, connected to process piping through tee-fittings. The method applies an impressed current to the anode while dynamically adjusting the voltage based on real-time measurements from the reference electrode. The system can include a dynamic offline test device for measuring current, voltage, and resistance of PFAS-contaminated aqueous streams to optimize cathodic protection.

### CROSS REFERENCE TO RELATED PATENT APPLICATIONS

This application claims priority to U.S. Appl. Ser. No. 63/701,464, filed Sep. 30, 2025 entitled “High Pressure And High Temperature Anode And Reference Electrodes Assemblies,” which patent application is commonly owned by the owner of the present invention. This patent application is incorporated herein in its entirety.

### TECHNICAL FIELD

The present disclosure relates to high-pressure and high-temperature electrode assemblies used in industrial processes. Specifically, the present disclosure relates to the protection of metallic components under high-pressure and high-temperature conditions, such as those found in supercritical water oxidation (SCWO) systems. The present disclosure further relates to the use of specially designed anode and reference electrode assemblies to prevent corrosion and heavy metal release, as well as a dynamic offline test device for measuring current, voltage, and resistance of per- and polyfluoroalkyl substances (PFAS) samples to ensure cathodic protection of SCWO system components.

### STATEMENT OF FEDERALLY FUNDED RESEARCH

None.

### BACKGROUND

Per- and polyfluoroalkyl substances (PFAS), including perfluorooctane sulfonate (PFOS) and perfluorooctanoic acid (PFOA), and hundreds of other similar compounds, have been widely used in the United States in a multitude of applications. There are significant concerns associated with these compounds due to widespread contamination coupled with uncertainties about risks to human health and the environment. PFAS are molecules having chains of carbon atoms surrounded by fluorine atoms. The C—F bond is very stable enabling the compounds to persist in the natural environment. Some PFAS include hydrogen, oxygen, sulfur, phosphorus, and/or nitrogen atoms. One example is PFOS:

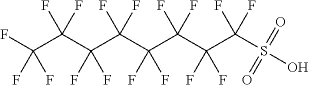 [SMILES: O=S(=O)(O)C(F)(F)C(F)(F)C(F)(F)C(F)(F)C(F)(F)C(F)(F)C(F)(F)C(F)(F)F]

Although some PFAS compounds with known human health risks have been voluntarily phased out (PFOA and PFOS), legacy contamination remains. Replacement PFAS compounds have been introduced with limited understanding of their health risks. PFAS contamination in drinking water sources in 1,582 locations in 49 states. Currently used techniques for treating PFAS-contaminated water are expensive, and management of spent media is costly and may result in long-term liability.

SCWO involves oxidation of aqueous organic compounds at temperatures and pressures above the critical point of water in the presence of an oxidant. SCWO is an energy intensive process which operates at high temperature and high pressure. Continuous operation under high oxidizing conditions poses challenges such as salt plugging and corrosion of the reactor construction materials. A review of some recent demonstrations of SCWO is provided by Kraus et al. in “Supercritical water oxidation as an innovative technology for PFAS destruction,” J. Environ. Eng. 148 (2022).

Metallic components in high-pressure and high-temperature environments, such as those found in supercritical water oxidation (SCWO) systems, are prone to corrosion and degradation. Supercritical water oxidation is an advanced oxidation process that occurs at conditions exceeding the critical point of water, typically around 374° C. and 22.1 MPa. This process effectively destroys per- and polyfluoroalkyl substances (PFAS) and other hazardous materials but introduces significant challenges in managing the equipment and materials used in SCWO systems. Specifically, corrosion of metallic components in SCWO reactors, such as the heat exchangers, salt separators, and reactors, is a persistent issue, leading to the release of harmful metals into the effluent stream.

The operating conditions of a SCWO continuous method and reactor (hereafter referred to as PFAS Annihilator™) have been developed and found to have several benefits for environmental remediation and waste management industries. The PFAS Annihilator™ consistently achieves near-complete destruction of PFAS, bringing the concentrations down to non-detect for most target PFAS, and consistently down to less than 70 ppt (parts per trillion) for all PFAS in under 30 seconds. This technology can be used to treat material contaminated with PFAS and other substances such as petroleum hydrocarbons or chlorinated solvents, which are also readily oxidized. Moreover, SCWO can be applied to a variety of PFAS-impacted liquids such as AFFF, landfill leachate, and investigation derived waste (IDW) due to its non-targeted carbon-fluorine bond destruction. The treated effluent is largely comprised of the products of complete combustion including carbon dioxide and water, and the corresponding anion acids; hence, the treated liquid can be released back into the environment after neutralization.

Table 1 lists the elemental composition of Inconel® 625, one of a few alloys used in the Annihilator™. This alloy is known to resist corrosion even in a high halogenated-compounds environment. In the Annihilator™, this alloy exhibits extensive corrosion, releasing nickel, chromium, and other heavy metals into the effluent. This invention prevents corrosion of the pipe, eliminating the release of heavy metals into the PFAS-free effluent.

| Alloy | Element | % Weight | |
|---|---|---|---|
| Inconel ® 625 | Ni | 58.0 | min |
| | Co | 1.0 | max |

| Cr | 20.0-23.0 | |
|---|---|---|
| Mo | 8.0-10.0 | |
| Fe | 5.0 | max |
| Nb (+Ta) | 3.15-4.15 | |
| Mn | 0.50 | max |
| Ti | 0.40 | max |
| Si | 0.50 | max |
| C | 0.10 | max |
| P | 0.015 | max |
| S | 0.015 | max |
| Al | 0.40 | max |

As shown below, in the oxidation potentials of the elemental component in Inconel® 625 shown through electrochemical series oxidation reactions for heavy metals, among the heavy metals, chromium is the most susceptible in the Annihilator™. Nickel, though, is found abundantly in the effluent because it is the major component in the alloy.

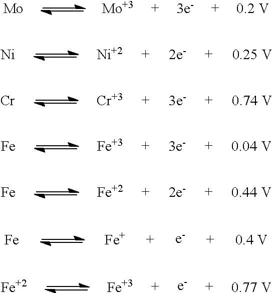

To address the problem of corrosion in apparatus for SCWO, we are investigating cathodic protection. Cathodic protection is known to be used to protect metallic objects, such as metallic pipes, from corrosion. Impressed current is a type of cathodic protection utilizing electrochemical means to obtain protection against corrosion in metal structures by applying a controlled electrical current to the metal. An impressed current cathodic protection (ICCP) system controls the corrosion of a metal by making it the cathode of an electrolytic cell. Any material, soil or solution that might have oxidative properties can serve as the anode. The principle of ICCP is to create an electrical potential difference between the metal structure to be protected (the cathode) and an inert anode. The potential difference should be negative enough to prevent an electrochemical reaction that causes corrosion. The electrons that flow from the metal structure to the anode provide a protective layer of electrons that prevents the reaction from occurring. An ICCP system is mainly composed of anodes attached to a DC power source (DC) or to a rectifier and an AC power source. The anode can be a more easily corroded “sacrificial” metal. This sacrificial metal corrodes preferentially while the more valuable metal object remains protected. In an ICCP system, however, the anode can be a sacrificial metal or a non-consumable material.

Impressed current systems are generally used in applications with high power demands, such as for large water storage tanks or where current requirements may change. The injected current should be just enough to overcome the original corrosion current and result in an impressed protection current, which flows in the complete circuit. The correct value of protection current can be determined by reference electrodes. Reference electrodes are typically made of either zinc or silver and may be used as the signal source to automatically regulate the value of protection current.

Current cathodic protection systems are not suitable for use in SCWO reactors due to their inability to withstand the extreme temperatures and pressures involved. Traditional anode and reference electrode assemblies degrade under these conditions, rendering them ineffective. Furthermore, the variability in PFAS samples processed in SCWO systems presents another challenge, as the current and voltage required for cathodic protection must be dynamically adjusted to match the specific composition of the effluent. Without this adjustment, the protective current may either fail to prevent corrosion or exceed safe levels, causing electrolysis of water and further degradation of the system's components.

To overcome these challenges, a specialized cathodic protection system must be designed to operate under high-pressure and high-temperature conditions. This includes the development of robust anode and reference electrode assemblies capable of withstanding the SCWO environment. These assemblies must provide reliable seals, electrical isolation, and structural integrity while preventing the release of heavy metals into the effluent. Additionally, a dynamic test device is required to measure and adjust the current, voltage, and resistance in real-time, ensuring that the correct protective current is applied for each unique PFAS sample processed in the SCWO reactor.

Despite the corrosion-resistant properties of Inconel® 625, the SCWO environment accelerates the oxidation process, leading to the formation of hexavalent chromium, a toxic and regulated substance. The presence of hexavalent chromium in the effluent requires additional treatment steps, adding to the complexity and cost of SCWO operations.

Accordingly, there is a need for high-pressure and high-temperature anode and reference electrode assemblies that can withstand the extreme conditions of SCWO systems, providing reliable cathodic protection and preventing the release of heavy metals into the effluent. There is also a need for a dynamic offline test device capable of measuring and adjusting current, voltage, and resistance for PFAS samples to ensure adequate protection of reactor components without causing electrolysis or further degradation.

### SUMMARY OF THE DISCLOSURE

The present disclosure is directed to systems and methods for providing cathodic protection in high-pressure and high-temperature environments, specifically for components used in supercritical water oxidation (SCWO) systems such as the PFAS Annihilator™. The disclosure includes specially designed anode and reference electrode assemblies capable of operating under extreme conditions to prevent corrosion and heavy metal release. Additionally, the disclosure provides a dynamic offline test device for measuring and adjusting current, voltage, and resistance for cathodic protection tailored to the specific composition of per- and polyfluoroalkyl substances (PFAS) samples.

The present disclosure employs high-pressure and high-temperature electrode assemblies that provide enhanced structural integrity, reliable seals, and electrical isolation, ensuring consistent protection for critical components in SCWO systems. These assemblies are designed to withstand the harsh operational conditions of SCWO reactors, where conventional electrode assemblies would fail. By preventing the degradation of metallic components, the disclosed systems minimize the release of toxic metals, such as chromium and nickel, into the effluent.

The dynamic offline test device provided in this disclosure allows for precise measurements of the current, voltage, and resistance of PFAS samples, ensuring optimal cathodic protection for the SCWO system components. This device enables operators to adjust the applied current and voltage dynamically, ensuring that the alloys used in the system, such as Inconel® 625, are adequately protected without causing electrolysis of water or overloading the system. The device is essential for maintaining the integrity of the SCWO system when processing varying PFAS samples with different compositions and reactivity.

To address the need for robust cathodic protection in high-pressure and high-temperature environments, the present disclosure provides electrode assemblies that maintain their structural integrity and functionality under the extreme conditions of SCWO reactors. The assemblies include specially designed seals and ceramic insulation to withstand the high pressures and temperatures encountered during operation, ensuring long-lasting and reliable performance.

In certain embodiments, the electrode assemblies include spiral grooves for enhanced mechanical strength and additional sealing elements at the colder ends of the assemblies. These features are designed to improve the overall durability and efficiency of the assemblies, further preventing corrosion and heavy metal release in SCWO applications. The use of advanced materials, such as Sauereisen ceramics, contributes to the assemblies' ability to resist the crushing pressures and extreme temperatures present in the SCWO environment.

Accordingly, the present disclosure provides systems and methods that offer a cost-effective and environmentally friendly alternative to conventional corrosion prevention techniques in SCWO systems. By preventing the degradation of reactor components and the release of toxic metals, the systems and methods disclosed herein ensure safer and more efficient operation of SCWO reactors, addressing the long-standing challenges of corrosion and effluent contamination in high-pressure and high-temperature processes.

In general, in one embodiment, the disclosure features a method for conducting supercritical water oxidation (SCWO) processes. The method can include an inlet for an aqueous stream. It can also include a first piping section connected on one side to the inlet for the aqueous stream and on another side to a SCWO reactor inlet. The method can further include a SCWO reactor disposed between the SCWO reactor inlet and a SCWO reactor outlet. The interior of the first piping section defines a pathway to the SCWO reactor. The system can include a cathodic protection system, which includes an electrical conduit connecting the first piping section, through a power source, to an anode. The anode can be disposed in a ceramic sealant within an anode housing, where the ceramic electrically insulates the anode from the housing. The housing can be attached to the first piping section at a tee joint. The anode can extend from the housing into the pathway. Additionally, a reference electrode can be positioned within the pathway.

In another embodiment, the disclosure features a method for conducting a supercritical water oxidation (SCWO) reaction. The method can include passing an aqueous solution through the pathway of the system of any foregoing clause and applying a voltage to the anode from the power source.

In another embodiment, the disclosure features a method for conducting a supercritical water oxidation (SCWO) reaction. The method can include passing a PFAS-contaminated aqueous solution into an inlet of a SCWO reactor system. It can include heating the PFAS-contaminated aqueous solution in the system to form a hot PFAS-contaminated aqueous solution in a pathway of the SCWO reactor system. The hot PFAS-contaminated aqueous solution at a temperature of at least 300° C. can contact an anode in the pathway. The method can include applying a voltage to the anode and conducting SCWO on the PFAS-contaminated aqueous solution in a SCWO reactor. The method can further include producing an effluent with a lower concentration of metal ions than if no voltage were applied.

In another embodiment, the disclosure features a method for conducting a supercritical water oxidation (SCWO) reaction. The method can include passing a PFAS-contaminated aqueous solution into an inlet of a SCWO reactor system. It can include heating the PFAS-contaminated aqueous solution in the system to form a hot PFAS-contaminated aqueous solution in a pathway of the SCWO reactor system. The hot PFAS-contaminated aqueous solution at a temperature of at least 300° C. can contact an anode in the pathway. The method can include applying a voltage to the anode and conducting SCWO on the PFAS-contaminated aqueous solution in a SCWO reactor. The method can further include producing an effluent with a lower concentration of metal ions than if no voltage were applied.

In another embodiment, the disclosure features a method for conducting a supercritical water oxidation (SCWO) reaction. The method can include passing a PFAS-contaminated aqueous solution into a first piping section connected on one side to an inlet for an aqueous stream and on another side to a SCWO reactor inlet. The method can include heating the PFAS-contaminated aqueous solution in the first piping section to form a heated PFAS-contaminated aqueous solution. The method can further include applying an electrical potential from a power source to an anode disposed within the heated PFAS-contaminated aqueous solution in the first piping section. The method can also include passing the heated PFAS-contaminated aqueous solution into a SCWO reactor and subjecting the PFAS-contaminated aqueous solution to supercritical conditions in the presence of an oxidant.

In another embodiment, the disclosure features a method for conducting a supercritical water oxidation (SCWO) reaction. The method can include passing a PFAS-contaminated aqueous solution into a first piping section connected on one side to an inlet for an aqueous stream and on another side to a SCWO reactor inlet. The method can include heating the PFAS-contaminated aqueous solution in the first piping section to form a heated PFAS-contaminated aqueous solution. The method can further include applying an electrical potential from a power source to an anode disposed within the heated PFAS-contaminated aqueous solution in the first piping section. The method can also include passing the heated PFAS-contaminated aqueous solution into a SCWO reactor and subjecting the PFAS-contaminated aqueous solution to supercritical conditions in the presence of an oxidant.

In another embodiment, the disclosure features a method for adjusting cathodic protection in a supercritical water oxidation (SCWO) process. The method can include determining the potential difference between the cathode and the surrounding aqueous fluid using a reference electrode. The method can further include adjusting the applied voltage to the anode to ensure cathodic protection is maintained across varying temperature and pressure conditions within the SCWO system.

### BRIEF DESCRIPTION OF THE DRAWINGS

Other advantages of the present disclosure will be apparent from the following detailed description of the disclosure in conjunction with embodiments as illustrated in the accompanying drawings, in which:

FIG. 1 depicts a graphite anode assembly, in accordance with certain embodiments of the present disclosure.

FIG. 2 depicts a reference electrode, in accordance with certain embodiments of the present disclosure.

FIG. 3 depicts combined anode and reference electrodes, in accordance with certain embodiments of the present disclosure.

FIG. 4 depicts a separate anode and reference electrodes' assemblies in separate tees, in accordance with certain embodiments of the present disclosure.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or a direct connection. Thus, if a first device couples to a second device, that connection may be through a direct connection or through an indirect connection via other devices and connections.

The terminology used herein is for the purpose of describing particular example embodiments only, and is not intended to be limiting. Following long-standing patent law convention, the terms “a” and “an” mean “one or more” when used in this application, including the claims.

As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. Accordingly, as an example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

In some embodiments, the overall process, or the supercritical water oxidation portion of the process, can be characterized by taking a PFAS-concentration of at least 100 ppm PFAS by weight (in some embodiments at least 500 ppm or at least 1000 ppm PFAS) to 1 ppm or less, or 0.1 ppm or less, or 0.01 ppm or less. Alternatively, by taking a PFOA-concentration of at least 100 ppm PFOA by weight (in some embodiments at least 500 ppm or at least 1000 ppm PFOA) to 1 ppm or less, or 0.1 ppm or less, or 0.01 ppm or less, or 1.0 ppb or less, or 0.1 ppb or less, or 0.01 ppb or less PFOA; in some embodiments in the range of 1 ppm to 5 ppt (part per trillion) PFOA. Alternatively, by taking a PFOS-concentration of at least 100 ppm PFOS by weight (in some embodiments at least 500 ppm or at least 1000 ppm PFOS) to 1 ppm or less, or 0.1 ppm or less, or 0.01 ppm or less, or 1.0 ppb or less, or 0.1 ppb or less, or 0.01 ppb or less PFOS; in some embodiments in the range of 1 ppm to 5 ppt (part per trillion) PFOS. The process can also be characterized by the same levels of destruction beginning with a PFAS concentration of less than 100 ppm. In some embodiments, PFAS-contaminated water comprising at least 1000 ppt of at least one (or at least 3 or at least 4 or at least 5 or at least 6) compound selected from the group consisting of PFHxA (perfluorohexanoic acid), PFHpA (perfluoroheptanoic acid), PFOA, PFBS (perfluorobutane sulfonate), PFHxS (perfluorohexane sulfonate), PFHpS (perfluoroheptane sulfonate), and PFOS and combinations thereof, treated by the process is (are) reduced by at least 2 (or at least 3 or at least 4 or at least 5) orders of magnitude. In some embodiments, PFAS-contaminated water comprising at least 100 ppt of at least one (or at least 3 or at least 4 or at least 5 or at least 6) compound selected from the group consisting of PFBA (perfluorobutanoic acid), PFPeA (perfluoropentanoic acid), PFHxA, PFHpA, PFOA, 6:2 FTS (6:2 fluorotelomer sulfonate), and 8:2 FTS (8:2 fluorotelomer sulfonate) and combinations thereof, treated by the process is (are) reduced by at least 2 (or at least 3 or at least 4 or at least 5) orders of magnitude and/or reduced to 5 ppt (or 1 ppt) or less.

For purposes of the present invention, a noble metal comprises gold, platinum, ruthenium, rhodium, palladium, osmium, and/or iridium, but may also include copper or silver, or any combination thereof.

For purposes of the present invention, a rectifier is an electrical device that converts alternating current (AC), which periodically reverses direction, to direct current (DC), which flows in only one direction.

Various aspects of the invention are described using the term “comprising;” however, in narrower embodiments, the invention may alternatively be described using the terms “consisting essentially of” or, more narrowly, “consisting of.”

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

### DETAILED DESCRIPTION OF THE DISCLOSURE

The present disclosure is directed to systems and methods for providing cathodic protection in supercritical water oxidation (SCWO) systems under high-pressure and high-temperature conditions. The system includes a cathodic protection system configured to prevent the corrosion of metallic components in the SCWO reactor. The system can include an anode and reference electrode assembly, where the anode is positioned within a ceramic housing that electrically insulates it from its surroundings. This assembly is connected to the piping system and provides reliable protection for the reactor components. The method further includes dynamic testing devices that optimize the current, voltage, and resistance settings for cathodic protection based on the specific conditions of the SCWO reactor, including the composition of per- and polyfluoroalkyl substances (PFAS) in the aqueous solution.

The disclosure provides sustainable devices, methods, and systems for cathodic protection that help solve the problems of the prior art by introducing specially designed electrode assemblies capable of operating in high-pressure and high-temperature environments, such as those found in SCWO processes. These assemblies are particularly suited for preventing corrosion in the SCWO reactor, heat exchanger, and salt separator. The system features ceramic sealants and insulation that withstand pressures up to 50 MPa and temperatures up to 700° C. Additionally, dynamic offline testing devices are provided to allow real-time adjustment of the cathodic protection system. These devices optimize the current and voltage required to protect the alloys used in SCWO systems, ensuring that corrosion is prevented while avoiding electrolysis of water, which could otherwise damage the system components.

In certain embodiments, the present disclosure is directed to systems and methods for providing cathodic protection in a high-temperature and high-pressure environment, such as in supercritical water oxidation (SCWO) processes. In some embodiments, the pipes of the SCWO reactor are subjected to varying pressures and temperatures. For example, typical process parameters of SCWO can include reaction temperatures of about 500-700° C. and pressures of about 24-50 MPa. The electrode assemblies containing the anode and/or the reference electrode can be subjected to similar high-pressure and high-temperature conditions.

In certain embodiments, impressed current can be applied to the anodic electrode assembly (or assemblies) before, during, and after the assembly is subjected to the SCWO environment. The applied voltage can be continually adjusted as temperature changes, based on the reference potential measured from the reference electrode. This allows for the impressed current to already be adjusted to the temperature of the application, ensuring full cathodic protection compared to having the anode at room temperature. These specially designed electrode assemblies are built for high-pressure and high-temperature applications and are intended to remain intact under SCWO or near-SCWO conditions. In some embodiments, the electrode assemblies can be constructed to withstand such conditions for 20 hours or more, 100 hours or more, or 1000 hours or more without failure.

In certain embodiments, the innovative aspects of the electrode assemblies can include an electrode assembly embodiment that ensures reliable and consistent seals, electrical isolation of electrode assemblies, easy manufacturability, enhanced strengthening of the assemblies' structure.

In some embodiments, there are devices, such as spark plugs, where electrodes are fixed within a ceramic. For example, spark plugs are devices with electrodes at least partially surrounded by ceramic. Spark plugs used in internal combustion engines have a high heat tolerance but cannot withstand high pressures and corrosive aqueous environments, as required for SCWO reactors.

In certain embodiments, an electrode assembly can include a housing or electrode tube, an electrode, at least one ceramic, a reducing union, and a tee-fitting. In preferred embodiments, the electrode tube, the reducing union, and the fittings can be composed of the same material as the process pipes. The electrode assemblies can be built by pre-swaging the electrode tube into the fittings, including the tees, so that when the ceramic is packed in and dried, the electrodes will not experience the crushing pressure of swaging. Since the ceramic can have a low coefficient of expansion, the ceramic will hold and not experience stress under the temperature conditions of the reactor. In some embodiments, spiral grooves can be disposed on the electrode tube for additional strength.

In some embodiments, a non-PFAS-containing ceramic cement, such as Sauereisen™, can be used to fix the anode in the electrode assembly. Other non-PFAS-containing sealants can be used as well, depending on the application. For example, at the colder end of the electrode assemblies, additional conventional sealants can be used.

In certain embodiments, the anode can be an electrically conductive nonmetal, such as conductive graphite produced by McMaster-Carr. Graphite does not dissolve, unlike metallic electrodes. Metal electrodes can be used in sacrificial anodes and are consumed, which could potentially increase the metal ion load of the waste stream. In some embodiments, reference electrodes can include platinum, silver, or any other noble metal. For example, platinum does not oxidize in air at any temperature but forms PtO2 on the surface of the electrode. Under operational temperatures, PtO2 will not dissolve into the process fluid.

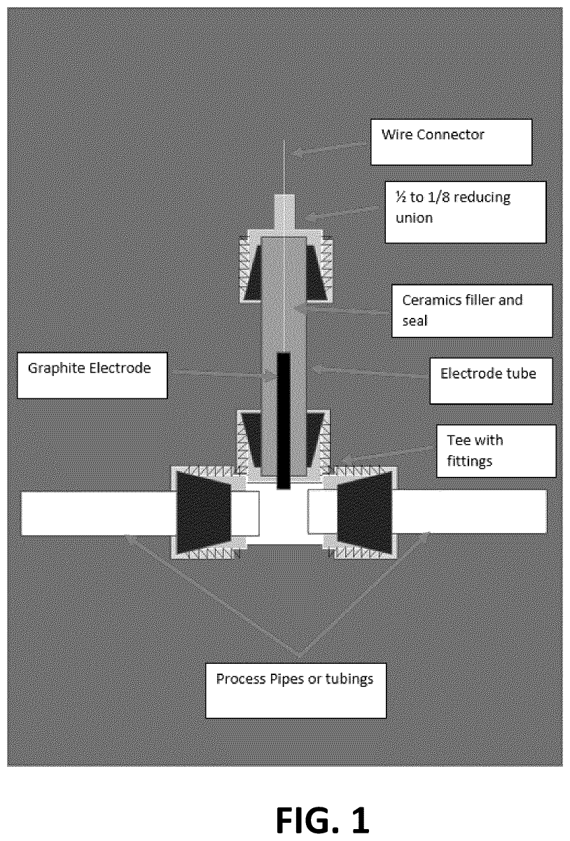

FIGS. 1, 2, 3, and 4 illustrate installed configurations of the electrode assemblies.

FIG. 1 depicts a graphite anode assembly, in accordance with certain embodiments of the present disclosure. The assembly is designed for use in high-pressure and high-temperature environments, such as those found in supercritical water oxidation (SCWO) processes. In some embodiments, the graphite anode assembly is positioned within the process piping or tubing, which facilitates the flow of the aqueous solution. The process pipe or tubing is attached to the tee-fitting, which is constructed of the same material as the surrounding process piping to maintain consistency in structural integrity under extreme conditions.

In certain embodiments, the anode is formed of graphite and is housed within an electrode tube. The electrode tube is also connected to a ceramic filler or seal, which electrically insulates the graphite anode from the surrounding components, such as the reducing union and the tee-fitting. The ceramic filler ensures that the anode remains isolated from the metal components of the system, preventing unwanted electrical conductivity. Additionally, the ceramic material used can withstand the high temperatures and pressures encountered during SCWO operations.

The electrode tube containing the graphite anode is secured in place using a ⅛ in. reducing union, which connects the tube to the surrounding components. In some embodiments, spiral grooves may be applied to the electrode tube to enhance its mechanical strength and ability to withstand high pressures without deformation.

A wire connector is attached to the anode, which connects the anode to an external power source, such as a DC power supply. The wire connector facilitates the transmission of electrical current to the graphite anode, ensuring that the appropriate impressed current can be applied to provide cathodic protection. This setup allows for consistent electrical isolation and ensures that the anode can operate effectively within the SCWO environment.

The depicted configuration ensures reliable and consistent seals within the system, enhanced structural integrity, and ease of manufacturability. In certain embodiments, this graphite anode assembly can be used to prevent corrosion of metallic components within the SCWO reactor by applying a controlled impressed current.

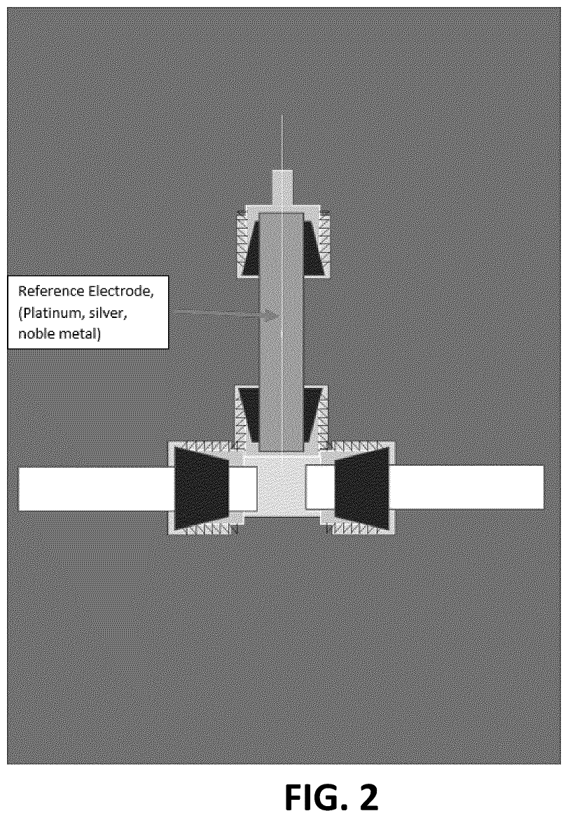

FIG. 2 depicts a reference electrode, in accordance with certain embodiments of the present disclosure. In some embodiments, the reference electrode is used to measure the potential between the cathode and the surrounding aqueous environment, ensuring that the cathodic protection system operates effectively under high-pressure and high-temperature conditions, such as those encountered in supercritical water oxidation (SCWO) processes.

In certain embodiments, the reference electrode can be constructed from noble metals such as platinum or silver, as indicated in the figure. These materials are selected due to their ability to resist corrosion and oxidation in extreme environments. Platinum, for example, does not oxidize in air at any temperature and forms a stable platinum dioxide (PtO2) layer on the surface. This oxide layer will not dissolve into the process fluid, making platinum an ideal material for use as a reference electrode in high-temperature applications.

The reference electrode is shown in FIG. 2 housed within an electrode tube that is electrically isolated from the surrounding components by a ceramic filler or seal. This ceramic material ensures that the reference electrode remains insulated from the metal parts of the SCWO system, allowing for accurate measurements of the potential difference between the reference electrode and the cathode.

In certain embodiments, the reference electrode assembly is connected to a measuring device, such as a voltmeter, via a wire connector. This wire allows the reference electrode to provide real-time feedback on the voltage potential, enabling the cathodic protection system to adjust the impressed current based on the operating conditions, such as temperature and pressure fluctuations in the SCWO reactor.

As depicted in FIG. 2, the reference electrode assembly is installed in-line with the process piping. The design ensures that the reference electrode is exposed to the process fluid, allowing it to take accurate readings of the electrochemical environment within the SCWO reactor. The use of noble metals like platinum or silver ensures the long-term stability of the electrode, even in highly corrosive or reactive environments.

In some embodiments, the housing for the reference electrode is constructed from the same material as the process piping to ensure mechanical integrity and uniform performance under SCWO conditions. The ceramic insulation prevents any unintended electrical interactions between the reference electrode and the surrounding metal components, ensuring the accuracy of the potential measurements.

The configuration illustrated in FIG. 2 is designed to provide reliable and consistent readings under extreme operating conditions, contributing to the overall effectiveness of the cathodic protection system in preventing corrosion of the SCWO reactor's metallic components.

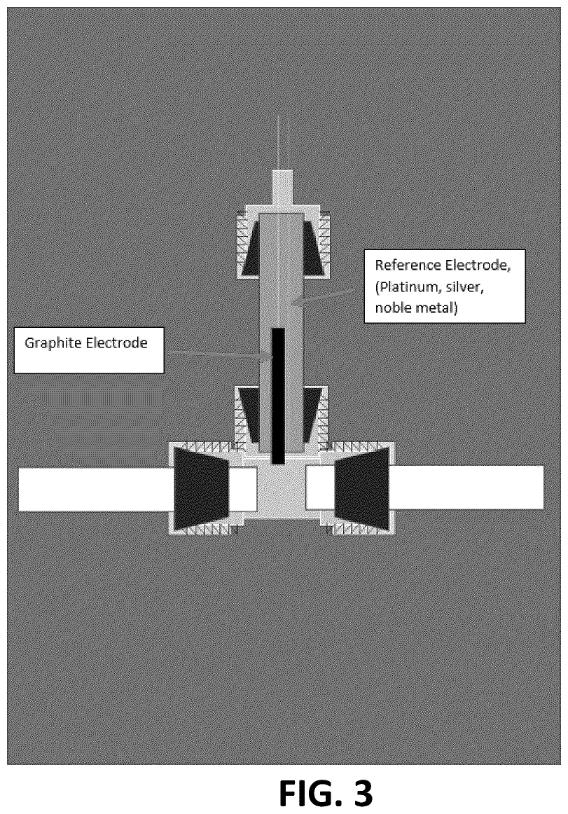

FIG. 3 depicts a combined anode and reference electrode assembly, in accordance with certain embodiments of the present disclosure. In some embodiments, this configuration is utilized in high-pressure and high-temperature environments, such as those found in supercritical water oxidation (SCWO) processes, where both cathodic protection and accurate voltage potential measurements are required for system integrity and performance.

In certain embodiments, the anode is constructed from graphite, which is an electrically conductive nonmetal known for its resistance to corrosion in high-temperature environments. The graphite anode, as illustrated in FIG. 3, is positioned alongside a reference electrode, which can be made from a noble metal such as platinum or silver. These materials are selected due to their resistance to oxidation and degradation under extreme conditions, making them suitable for long-term use in SCWO processes.

The combined anode and reference electrodes are housed within an electrode tube that is insulated from the surrounding metal components by ceramic filler or seals. In some embodiments, this ceramic material ensures electrical isolation between the electrodes and the rest of the SCWO system, allowing for both the cathodic protection provided by the graphite anode and accurate potential measurements from the reference electrode. The ceramic insulation also provides resistance to the high temperatures and pressures typical of SCWO environments, ensuring that the assembly remains functional over extended operational periods.

As depicted, the reference electrode, which can be platinum, silver, or any other noble metal, provides a stable reference point for measuring the potential difference within the SCWO reactor. This measurement allows the cathodic protection system to adjust the impressed current in real-time based on the electrochemical conditions inside the reactor, such as fluctuations in temperature and pressure. The graphite anode, on the other hand, ensures that the metallic components of the reactor are protected from corrosion by providing electrons to any surrounding materials with oxidative properties.

In some embodiments, the electrode tube that houses the graphite anode and reference electrode is connected to a reducing union and a tee-fitting. These components are typically made from the same material as the process piping to maintain uniform mechanical integrity and resistance to the operational conditions of the SCWO reactor. Spiral grooves may also be imposed on the electrode tube for additional strength and to enhance the tube's ability to withstand high pressures without deforming.

The wire connectors shown in FIG. 3 allow the anode and reference electrodes to interface with external systems. In certain embodiments, the graphite anode is connected to a DC power supply or rectifier, which provides the impressed current necessary for cathodic protection. The reference electrode, on the other hand, is connected to a measuring device, such as a voltmeter, allowing real-time monitoring of the voltage potential between the reference electrode and the metallic components of the SCWO reactor.

The combined anode and reference electrode assembly depicted in FIG. 3 ensures that both corrosion prevention and accurate voltage measurements are achieved within the SCWO environment, contributing to the overall effectiveness of the system.

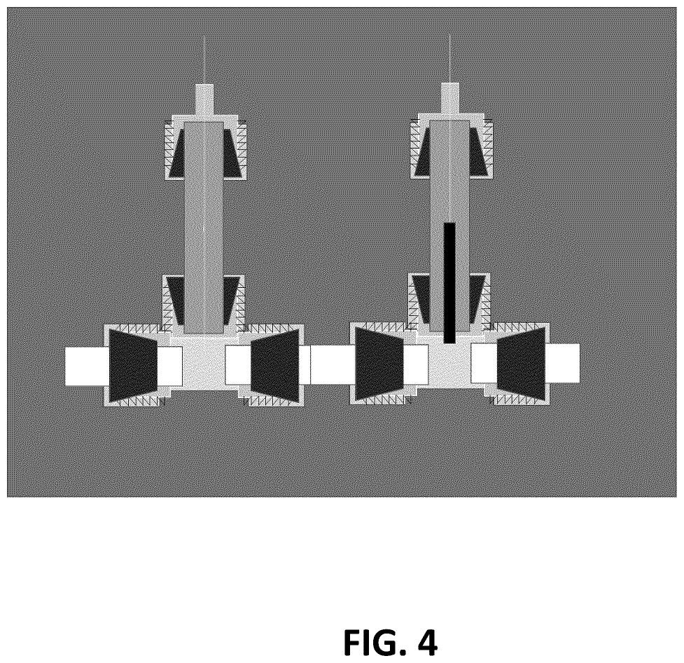

FIG. 4 depicts separate anode and reference electrode assemblies positioned in separate tees, in accordance with certain embodiments of the present disclosure. This configuration is designed for use in high-pressure and high-temperature environments, such as in supercritical water oxidation (SCWO) processes, where both cathodic protection and accurate potential measurements are necessary to maintain system performance and prevent corrosion.

In certain embodiments, the anode assembly is positioned in one tee-fitting, while the reference electrode assembly is housed in a separate tee-fitting. This separation allows for independent placement of the anode and reference electrode, ensuring that both components can function optimally in their respective locations within the SCWO reactor system.

In some embodiments, the anode is constructed from graphite, a nonmetal known for its high conductivity and resistance to corrosion in extreme conditions. The graphite anode is housed within an electrode tube and insulated from the surrounding metal components by ceramic fillers or seals. This ceramic insulation ensures electrical isolation of the anode, allowing it to function as the primary source of electrons for cathodic protection. The ceramic material can withstand the high temperatures and pressures present in the SCWO process, ensuring the durability and longevity of the anode assembly.

The reference electrode assembly is similarly housed in an electrode tube, with ceramic insulation to prevent electrical conductivity between the reference electrode and the surrounding metal components. In certain embodiments, the reference electrode is made from noble metals such as platinum or silver, materials chosen for their resistance to oxidation and corrosion in extreme environments. The reference electrode provides real-time measurements of the potential difference between the cathode and the surrounding aqueous environment, allowing the system to adjust the impressed current applied to the anode for optimal cathodic protection.

The two assemblies, depicted in FIG. 4, are installed in separate tee-fittings, which are connected to the process piping. In certain embodiments, the fittings and piping are made from the same material, typically a high-temperature nickel alloy such as Hastelloy, ensuring mechanical integrity under the extreme conditions of the SCWO process. The tee-fittings are designed to provide structural support to the electrode assemblies while maintaining their electrical isolation.

In some embodiments, spiral grooves may be included in the electrode tube to enhance mechanical strength and resistance to deformation under high pressures. The separation of the anode and reference electrode into distinct assemblies allows for flexible placement within the SCWO reactor system, enabling precise control of cathodic protection and potential measurements.

Wire connectors, as shown in FIG. 4, connect the anode and reference electrode assemblies to external devices. The anode is connected to a DC power supply or rectifier, which provides the impressed current required for cathodic protection. The reference electrode is connected to a voltmeter or similar measuring device, allowing for continuous monitoring of the voltage potential between the reference electrode and the metallic components of the SCWO system.

In certain embodiments, the configuration illustrated in FIG. 4 ensures effective corrosion prevention and accurate potential measurement, contributing to the overall efficiency and durability of the SCWO reactor system. The separate assemblies for the anode and reference electrode allow for independent control and maintenance, improving the flexibility and reliability of the system under extreme operating conditions.

Accordingly, in some embodiments, the electrode structural holder can comprise at least one ceramic. The one or more ceramics can serve as a filler and/or as a sealant. The ceramic(s) can insulate the electrode from the housing, also referred to as the electrode tube, as shown in FIGS. 3-6. The housing can be constructed of the same refined metal as the process pipes. In certain embodiments, the structure can be designed to reverse Pascal's Principle due to the use of a reducing union away from the high-pressure area. Wire connectors, which are typically ordinary wires, can connect the electrodes to external devices. The wire connector for the anode can connect the anode to a DC power supply or rectifier. The wire connector for the reference electrode can connect the electrode to a measuring device, such as a voltmeter.

In certain embodiments, a SCWO reactor system can include an inlet for an aqueous stream, a first piping section connected on one side to the inlet for an aqueous stream and connected on another side to a SCWO reactor inlet, a SCWO reactor outlet, and a SCWO reactor disposed between the SCWO reactor inlet and the SCWO reactor outlet. In preferred embodiments, the SCWO reactor outlet can be connected to a second piping section. Typically, the first piping section, the second piping section, and the SCWO reactor are formed of the same material, often a metal alloy designed for high-temperature operation. In certain embodiments, the material can be a nickel alloy, such as Hastelloy. High-temperature alloys are a well-known set of materials, many of which are designed for use in aircraft components. In some embodiments, the second section of piping and, especially, the first section of piping can include several components, such as a solids separator, one or more heat exchangers, inlets for oxidants or other solutions, and a mixing zone, which can optionally contain a static mixer. Frequently, the second piping section can transfer heat to the first piping section in a heat exchange zone. The first piping section is at least 5 cm long and can be longer, for example, at least 20 cm or at least 1 m, or up to 10 m or more.

In certain embodiments, the disclosure provides for a dynamic test device that allows for real-time measurement and adjustment of cathodic protection parameters such as current, voltage, and resistance. This device can be particularly important when dealing with varying compositions of per- and polyfluoroalkyl substances (PFAS) in the aqueous stream being treated in the SCWO process. The dynamic test device can include a current measuring unit, a voltage adjusting unit, and a resistance measuring unit. These units work in tandem to ensure that the cathodic protection system is optimized for the specific conditions present in the SCWO reactor at any given time.

The current measuring unit can be configured to detect the protective current required for different PFAS compositions. In certain embodiments, the voltage adjusting unit can regulate the applied voltage to the anode based on real-time measurements from the reference electrode, ensuring that the cathodic protection system maintains optimal performance under varying temperature and pressure conditions. The resistance measuring unit can account for the system's impedance, preventing excessive current flow that could otherwise result in electrolysis of water, which would be detrimental to the SCWO system components.

In some embodiments, the dynamic test device can automatically detect changes in the PFAS composition in real-time and adjust the protective current and voltage accordingly, ensuring continued protection of the SCWO system components. This dynamic capability reduces the need for manual intervention and increases the reliability of the system, particularly in situations where the composition of the incoming aqueous stream fluctuates.

The dynamic test device can be used to apply the current and voltage based on the most reactive elemental metal composition of the alloys used in critical components of the SCWO system, such as the reactor, heat exchanger, and salt separator. For instance, if the alloy in the reactor is more susceptible to corrosion due to the presence of a particular PFAS compound, the dynamic test device can increase the protective current to prevent degradation of the material.

In some embodiments, the method of adjusting cathodic protection in a SCWO process can include determining the potential difference between the cathode (e.g., the SCWO reactor piping or components) and the surrounding aqueous fluid using a reference electrode. This measurement can allow the system to dynamically adjust the applied voltage to the anode, ensuring that the appropriate level of cathodic protection is maintained across varying temperature and pressure conditions. For example, as the SCWO system operates at temperatures of 500-700° C. and pressures up to 50 MPa, the electrical potential required to maintain cathodic protection can vary. The system can be configured to account for these variations and adjust the voltage accordingly.

In some embodiments, the applied voltage can also be adjusted based on the impedance of the SCWO system and the specific composition of the PFAS-contaminated aqueous solution. This adjustment ensures that system components are protected without causing unwanted electrolysis of water, which could damage the SCWO system. Real-time impedance measurements can help the system detect when conditions have changed and trigger the appropriate voltage adjustment to maintain protection.

Additionally, in certain embodiments, dynamic offline testing can be conducted to determine the appropriate current and voltage levels for protecting metallic components of the SCWO system under high-temperature and high-pressure conditions. This offline testing can help establish baseline settings for the dynamic test device, which can then be used to make real-time adjustments during operation.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the disclosure have been shown and described, modifications thereof can be made by one skilled in the art without departing from the spirit and teachings of the disclosure. The embodiments described and the examples provided herein are exemplary only, and are not intended to be limiting. Many variations and modifications of the disclosure disclosed herein are possible and are within the scope of the disclosure. The scope of protection is not limited by the description set out above, but is only limited by the claims which follow, that scope including all equivalents of the subject matter of the claims.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Those skilled in the art will appreciate that the steps described herein may be carried out in a variety ways and that no particular ordering is required. It will be further understood from the foregoing description that modifications and changes may be made in various embodiments of the present disclosure without departing from its true spirit. The descriptions in this specification are for purposes of illustration only and are not to be construed in a limiting sense.

Consistent with the above disclosure, the examples of systems and methods enumerated in the following clauses are specifically contemplated and are intended as a non-limiting set of examples.

Clause 1. A system for conducting supercritical water oxidation (SCWO) processes, including an inlet for an aqueous stream; a first piping section connected on one side to the inlet for the aqueous stream and on another side to a SCWO reactor inlet; a SCWO reactor disposed between the SCWO reactor inlet and a SCWO reactor outlet; where the interior of the first piping section defines a pathway to the SCWO reactor; and a cathodic protection system including an electrical conduit connecting the first piping section, through a power source, to an anode; where the anode is disposed in a ceramic sealant within an anode housing, the ceramic electrically insulating the anode from the housing; where the housing is attached to the first piping section at a tee joint; where the anode extends from the housing into the pathway; and a reference electrode positioned within the pathway.

Clause 2. The system of any foregoing clause, where the anode includes graphite.

Clause 3. The system of any foregoing clause, where the reference electrode includes a noble metal.

Clause 4. The system of any foregoing clause, where the housing, reducing union, and tee-fitting are made of the same material as the first piping section.

Clause 5. The system of any foregoing clause, where the anode is in contact with an aqueous process fluid in the pathway.

Clause 6. The system of any foregoing clause, where the ceramic is in contact with the aqueous process fluid.

Clause 7. The system of any foregoing clause, where the SCWO reactor includes an aqueous solution at a temperature in the range of 500° C. to 700° C. and pressures in the range of 24 MPa to 50 MPa.

Clause 8. The system of any foregoing clause, where the reference electrode is configured to measure the potential difference between the cathode and the surrounding environment under varying temperature and pressure conditions, ensuring cathodic protection is adapted to the supercritical water oxidation (SCWO) process.

Clause 9. The system of any foregoing clause, where the ceramic sealant includes a material selected from non-perfluoroalkyl-containing ceramics capable of withstanding pressures up to 50 MPa and temperatures up to 700° C.

Clause 10. The system of any foregoing clause, further including spiral grooves imposed on the electrode tube holder to enhance mechanical strength and durability of the electrode assemblies.

Clause 11. The system of any foregoing clause, where the anode housing is configured to prevent leakage of process fluids into the anode assembly and maintain electrical insulation even at temperatures exceeding 400° C.

Clause 12. The system of any foregoing clause, further including a sealing mechanism at the colder end of the electrode assemblies to provide additional protection against leakage under high-pressure conditions.

Clause 13. The system of any foregoing clause, where the electrode assemblies are configured to maintain structural integrity by preventing swaging pressure from damaging the ceramic when packed within the assembly.

Clause 14. A method for conducting a supercritical water oxidation (SCWO) reaction, including passing an aqueous solution through the pathway of the system of any foregoing clause and applying a voltage to the anode from the power source.

Clause 15. The method of any foregoing clause, where the temperature of the aqueous solution at the point where the anode extends into the pathway is in the range of 200° C. to 400° C. at subcritical conditions.

Clause 16. The method of any foregoing clause, where the SCWO reactor includes an aqueous solution at a temperature in the range of 500° C. to 700° C. and pressures in the range of 24 MPa to 50 MPa.

Clause 17. A method for conducting a supercritical water oxidation (SCWO) reaction, including passing a PFAS-contaminated aqueous solution into an inlet of a SCWO reactor system; heating the PFAS-contaminated aqueous solution in the system to form a hot PFAS-contaminated aqueous solution in a pathway of the SCWO reactor system; where the hot PFAS-contaminated aqueous solution at a temperature of at least 300° C. contacts an anode in the pathway; applying a voltage to the anode; conducting SCWO on the PFAS-contaminated aqueous solution in a SCWO reactor; and producing an effluent with a lower concentration of metal ions than if no voltage were applied.

Clause 18. A method for conducting a supercritical water oxidation (SCWO) reaction, including passing a PFAS-contaminated aqueous solution into an inlet of a SCWO reactor system; heating the PFAS-contaminated aqueous solution in the system to form a hot PFAS-contaminated aqueous solution in a pathway of the SCWO reactor system; where the hot PFAS-contaminated aqueous solution at a temperature of at least 300° C. contacts an anode in the pathway; applying a voltage to the anode; conducting SCWO on the PFAS-contaminated aqueous solution in a SCWO reactor; and producing an effluent with a lower concentration of metal ions than if no voltage were applied.

Clause 19. A method for conducting a supercritical water oxidation (SCWO) reaction, including passing a PFAS-contaminated aqueous solution into a first piping section connected on one side to an inlet for an aqueous stream and on another side to a SCWO reactor inlet; heating the PFAS-contaminated aqueous solution in the first piping section to form a heated PFAS-contaminated aqueous solution; applying an electrical potential from a power source to an anode disposed within the heated PFAS-contaminated aqueous solution in the first piping section; and passing the heated PFAS-contaminated aqueous solution into a SCWO reactor and subjecting the PFAS-contaminated aqueous solution to supercritical conditions in the presence of an oxidant.

Clause 20. The dynamic test device of any foregoing clause, where the anode is selected from materials including graphite, metal oxides, or ceramics, tailored to withstand the temperature and pressure conditions within the SCWO reactor.

Clause 21. The dynamic test device of any foregoing clause, further configured to detect and adjust for changes in the composition of PFAS samples in real-time to ensure continued cathodic protection without compromising the integrity of SCWO system components.

Clause 22. The dynamic test device of any foregoing clause, where the system applies the current and voltage based on the most reactive elemental metal composition of alloys used in the SCWO reactor, heat exchanger, and salt separator.

Clause 23. A method for conducting a supercritical water oxidation (SCWO) reaction, including passing a PFAS-contaminated aqueous solution into a first piping section connected on one side to an inlet for an aqueous stream and on another side to a SCWO reactor inlet; heating the PFAS-contaminated aqueous solution in the first piping section to form a heated PFAS-contaminated aqueous solution; applying an electrical potential from a power source to an anode disposed within the heated PFAS-contaminated aqueous solution in the first piping section; and passing the heated PFAS-contaminated aqueous solution into a SCWO reactor and subjecting the PFAS-contaminated aqueous solution to supercritical conditions in the presence of an oxidant.

Clause 24. A dynamic offline test device for measuring current, voltage, and resistance of per- and polyfluoroalkyl substances (PFAS) samples to optimize cathodic protection for supercritical water oxidation (SCWO) system components, including a current measuring unit configured to detect the protective current required for different PFAS compositions; a voltage adjusting unit configured to regulate the applied voltage to ensure protection of SCWO system components based on the most reactive elemental composition of the system alloys; and a resistance measuring unit configured to account for the impedance of the SCWO system and prevent excessive current flow that could result in electrolysis of water.

Clause 25. The dynamic test device of any foregoing clause, where the anode is selected from materials including graphite, metal oxides, or ceramics, tailored to withstand the temperature and pressure conditions within the SCWO reactor.

Clause 26. The dynamic test device of any foregoing clause, further configured to detect and adjust for changes in the composition of PFAS samples in real-time to ensure continued cathodic protection without compromising the integrity of SCWO system components.

Clause 27. The dynamic test device of any foregoing clause, where the system applies the current and voltage based on the most reactive elemental metal composition of alloys used in the SCWO reactor, heat exchanger, and salt separator.

Clause 28. A method for adjusting cathodic protection in a supercritical water oxidation (SCWO) process, including determining the potential difference between the cathode and the surrounding aqueous fluid using a reference electrode and adjusting the applied voltage to the anode to ensure cathodic protection is maintained across varying temperature and pressure conditions within the SCWO system.

Clause 29. The method of any foregoing clause, where the applied voltage is adjusted based on the impedance of the SCWO system and the specific composition of the PFAS-contaminated aqueous solution, ensuring the protection of system components while preventing electrolysis.

Clause 30. The method of any foregoing clause, where dynamic offline testing is conducted to determine the appropriate current and voltage for protecting metallic components of the SCWO system under high-temperature and high-pressure conditions.

What is claimed is:

1. A system for conducting supercritical water oxidation (SCWO) processes, comprising:
an inlet for an aqueous stream;
a first piping section connected on one side to the inlet for the aqueous stream and on another side to a SCWO reactor inlet;
a SCWO reactor disposed between the SCWO reactor inlet and a SCWO reactor outlet;
wherein the interior of the first piping section defines a pathway to the SCWO reactor; and
a cathodic protection system comprising:
an electrical conduit connecting the first piping section, through a power source, to an anode;
wherein the anode is disposed in a ceramic sealant within an anode housing, the ceramic electrically insulating the anode from the housing;
wherein the housing is attached to the first piping section at a tee joint;
wherein the anode extends from the housing into the pathway; and
a reference electrode positioned within the pathway.

2. The system of claim 1, wherein the anode comprises graphite.

3. The system of claim 1, wherein the reference electrode comprises a noble metal.

4. The system of claim 1, wherein the housing, reducing union, and tee-fitting are made of the same material as the first piping section.

5. The system of claim 1, wherein the anode is in contact with an aqueous process fluid in the pathway.

6. The system of claim 1, wherein the ceramic is in contact with the aqueous process fluid.

7. The system of claim 1, wherein the SCWO reactor comprises an aqueous solution at a temperature in the range of 500° C. to 700° C. and pressures in the range of 24 MPa to 50 MPa.

8. The system of claim 1, wherein the reference electrode is configured to measure the potential difference between the cathode and surrounding environment under varying temperature and pressure conditions, ensuring cathodic protection is adapted to the supercritical water oxidation (SCWO) process.

9. The system of claim 1, wherein the ceramic sealant comprises a material selected from non-perfluoroalkyl-containing ceramics capable of withstanding pressures up to 50 MPa and temperatures up to 700° C.

10. The system of claim 1, further comprising spiral grooves imposed on the electrode tube holder to enhance mechanical strength and durability of the electrode assemblies.

11. The system of claim 1, wherein the anode housing is configured to prevent leakage of process fluids into the anode assembly and maintain electrical insulation even at temperatures exceeding 400° C.

12. The system of claim 1, further comprising a sealing mechanism at the colder end of the electrode assemblies to provide additional protection against leakage under high-pressure conditions.

13. The system of claim 1, wherein the electrode assemblies are configured to maintain structural integrity by preventing swaging pressure from damaging the ceramic when packed within the assembly.

14. A method for conducting a supercritical water oxidation (SCWO) reaction, comprising passing an aqueous solution through the pathway of the system of claim 1; and applying a voltage to the anode from the power source.

15. The method of claim 14, wherein the temperature of the aqueous solution at the point where the anode extends into the pathway is in the range of 200° C. to 400° C. at subcritical conditions.

16. The method of claim 15, wherein the SCWO reactor comprises an aqueous solution at a temperature in the range of 500° C. to 700° C. and pressures in the range of 24 MPa to 50 MPa.

17. A method for conducting a supercritical water oxidation (SCWO) reaction, comprising:
passing a PFAS-contaminated aqueous solution into an inlet of a SCWO reactor system;
heating the PFAS-contaminated aqueous solution in the system to form a hot PFAS-contaminated aqueous solution in a pathway of the SCWO reactor system;
wherein the hot PFAS-contaminated aqueous solution at a temperature of at least 300° C. contacts an anode in the pathway;
applying a voltage to the anode;
conducting SCWO on the PFAS-contaminated aqueous solution in a SCWO reactor; and
producing an effluent with a lower concentration of metal ions than if no voltage were applied.

18. A method for conducting a supercritical water oxidation (SCWO) reaction, comprising:
passing a PFAS-contaminated aqueous solution into an inlet of a SCWO reactor system;
heating the PFAS-contaminated aqueous solution in the system to form a hot PFAS-contaminated aqueous solution in a pathway of the SCWO reactor system;
wherein the hot PFAS-contaminated aqueous solution at a temperature of at least 300° C. contacts an anode in the pathway;
applying a voltage to the anode;
conducting SCWO on the PFAS-contaminated aqueous solution in a SCWO reactor; and
producing an effluent with a lower concentration of metal ions than if no voltage were applied.

19. A method for conducting a supercritical water oxidation (SCWO) reaction, comprising:
passing a PFAS-contaminated aqueous solution into a first piping section connected on one side to an inlet for an aqueous stream and on another side to a SCWO reactor inlet;
heating the PFAS-contaminated aqueous solution in the first piping section to form a heated PFAS-contaminated aqueous solution;
applying an electrical potential from a power source to an anode disposed within the heated PFAS-contaminated aqueous solution in the first piping section; and
passing the heated PFAS-contaminated aqueous solution into a SCWO reactor and subjecting the PFAS-contaminated aqueous solution to supercritical conditions in the presence of an oxidant.
A dynamic offline test device for measuring current, voltage, and resistance of per- and polyfluoroalkyl substances (PFAS) samples to optimize cathodic protection for supercritical water oxidation (SCWO) system components, comprising:
a current measuring unit configured to detect the protective current required for different PFAS compositions;
a voltage adjusting unit configured to regulate the applied voltage to ensure protection of SCWO system components based on the most reactive elemental composition of the system alloys; and
a resistance measuring unit configured to account for the impedance of the SCWO system and prevent excessive current flow that could result in electrolysis of water.

20. The dynamic test device of claim 19, wherein the anode is selected from materials comprising graphite, metal oxides, or ceramics, tailored to withstand the temperature and pressure conditions within the SCWO reactor.

21. The dynamic test device of claim 19, further configured to detect and adjust for changes in the composition of PFAS samples in real-time to ensure continued cathodic protection without compromising the integrity of SCWO system components.

22. The dynamic test device of claim 19, wherein the system applies the current and voltage based on the most reactive elemental metal composition of alloys used in the SCWO reactor, heat exchanger, and salt separator.

23. A method for conducting a supercritical water oxidation (SCWO) reaction, comprising:
passing a PFAS-contaminated aqueous solution into a first piping section connected on one side to an inlet for an aqueous stream and on another side to a SCWO reactor inlet;
heating the PFAS-contaminated aqueous solution in the first piping section to form a heated PFAS-contaminated aqueous solution;
applying an electrical potential from a power source to an anode disposed within the heated PFAS-contaminated aqueous solution in the first piping section; and
passing the heated PFAS-contaminated aqueous solution into a SCWO reactor and subjecting the PFAS-contaminated aqueous solution to supercritical conditions in the presence of an oxidant.

24. A dynamic offline test device for measuring current, voltage, and resistance of per- and polyfluoroalkyl substances (PFAS) samples to optimize cathodic protection for supercritical water oxidation (SCWO) system components, comprising:
a current measuring unit configured to detect the protective current required for different PFAS compositions;
a voltage adjusting unit configured to regulate the applied voltage to ensure protection of SCWO system components based on the most reactive elemental composition of the system alloys; and
a resistance measuring unit configured to account for the impedance of the SCWO system and prevent excessive current flow that could result in electrolysis of water.

25. The dynamic test device of claim 24, wherein the anode is selected from materials comprising graphite, metal oxides, or ceramics, tailored to withstand the temperature and pressure conditions within the SCWO reactor.

26. The dynamic test device of claim 24, further configured to detect and adjust for changes in the composition of PFAS samples in real-time to ensure continued cathodic protection without compromising the integrity of SCWO system components.

27. The dynamic test device of claim 24, wherein the system applies the current and voltage based on the most reactive elemental metal composition of alloys used in the SCWO reactor, heat exchanger, and salt separator.

28. A method for adjusting cathodic protection in a supercritical water oxidation (SCWO) process, comprising:
determining the potential difference between the cathode and the surrounding aqueous fluid using a reference electrode; and
adjusting the applied voltage to the anode to ensure cathodic protection is maintained across varying temperature and pressure conditions within the SCWO system.

29. The method of claim 28, wherein the applied voltage is adjusted based on the impedance of the SCWO system and the specific composition of the PFAS-contaminated aqueous solution, ensuring the protection of system components while preventing electrolysis.

30. The method of claim 28, wherein dynamic offline testing is conducted to determine the appropriate current and voltage for protecting metallic components of the SCWO system under high-temperature and high-pressure conditions.
